(19) United States
(12) Patent Application Publication
(10) Pub. No.: US 2006/0047926 A1
(43) Pub. Date: Mar. 2, 2006

(54) Managing multiple snapshot copies of data

(76) Inventor: Calvin Guowei Zheng, Camarillo, CA (US)

Correspondence Address: Phil Virga, 1525 Aviation Blvd., #105, Redondo Beach, CA, 90278, US

(21) Appl. No.: 10/925,803

(22) Filed: Aug. 25, 2004

(51) Int. Cl. G06F 12/16

(52) U.S. Cl. 711/162; 711/202

(57) ABSTRACT

A method for providing multiple, different point-in-time, and read and write accessible snapshot copies of a base disk in storage arrays is disclosed. The method improves the performance of multiple snapshots by linking them together and sharing only one copy of a unique data block. This method also has the benefit of saving snapshot disk space by dynamically allocating additional space required according to the actual usage. Additionally, only one copy-on-write procedure needs to be performed for multiple snapshot volumes during access to either the base disk volume, or any of the snapshots that is attached to the base disk. When a snapshot volume is deleted, disk space and data structure dedicated to that snapshot volume are also deleted, so that storage space and memory resource within the snapshots may be reused for subsequent applications. Additionally, multiple snapshots can be managed in a fashion such that multiple, different point-in-time copies of the base disk can be maintained and updated automatically.

Current high-capacity computerized data storage systems typically involve a storage area network (SAN) within which one or more storage arrays store data on behalf of one or more host devices, which in turn typically service data storage requirements of several client devices. Within such a storage system, various techniques are employed to make an image or copy of the data. One such technique involves the making of “snapshot” or point-in-time copies of volumes of data within the storage arrays without taking the original data “offline,” or making the data temporarily unavailable. Generally, a snapshot volume represents the state of the original, or base, volume at a particular point in time.

Thus, the snapshot volume is said to contain a copy or picture, i.e. “snapshot,” of the base volume.

Snapshot volumes are formed to preserve the state of the base volume for various purposes. For example, daily snapshot volumes may be formed in order to show and compare daily changes to the data. Also, a business or enterprise may want to upgrade its software that uses the base volume from an old version of the software to a new version. Before making the upgrade, however, the user, or operator, of the software can form a snapshot volume of the base volume and concurrently run the new untested version of the software on the snapshot volume and the older known stable version of the software on the base volume. The user can then compare the results of both versions, thereby testing the new version for errors and efficiency before actually switching to using the new version of the software with the base volume. Also, the user can make a snapshot volume from the base volume in order to run the data in the snapshot volume through various different scenarios (e.g. financial data manipulated according to various different economic scenarios) without changing or corrupting the original data in the base volume. Additionally, backup volumes (e.g. tape backups) of the base volume can be formed from a snapshot volume of the base volume, so that the base volume does not have to be taken offline, or made unavailable, for an extended period of time to perform the backup, since the formation of the snapshot volume takes considerably less time than does the formation of the backup volume.

The first time that data is written to a data block in the base volume after forming a snapshot volume, a copy-on-write procedure is performed to copy the original data block from the base volume to the snapshot before writing the new data to the base volume. Afterwards, it is not necessary to copy the data block to the snapshot volume upon subsequent writes to the same data block in the base volume.

When multiple snapshot volumes have been formed, with every write procedure to a previously unchanged data block of the base volume, a copy-on-write procedure must occur for every affected snapshot volume to copy the prior data from the base volume to each of the snapshot volumes. Therefore, with several snapshot volumes, the copying process can take up a considerable amount of the storage array's processing time, and the snapshot volumes can take up a considerable amount of the storage array's storage capacity.

### SUMMARY

A method for providing a plurality of different point-in-time, read and write accessible snapshot copies of a base disk volume in storage arrays is disclosed. The method improves the performance of multiple snapshots by linking them together and sharing only one copy of a unique data block. This method also has the benefit of saving snapshot disk space by dynamically allocating additional space required according to the actual usage. Additionally, only one copy-on-write procedure needs to be performed for multiple snapshot volumes during access to either the base disk volume, or any of the snapshots that is attached to the base disk. When a snapshot volume is deleted, disk space and data structure dedicated to that snapshot volume are also deleted, so that storage space and memory resource within the snapshots may be reused for subsequent applications. Additionally, multiple snapshots can be managed in a fashion such that multiple, different point-in-time copies of the base disk can be maintained and updated automatically.

### BRIEF DESCRIPTION OF THE DRAWING

FIG. 1 is a block diagram of one example of a storage area network (SAN).

FIG. 2 is a block diagram of a storage array incorporated in the SAN shown in FIG. 1.

FIG. 3 is a diagram illustrating a memory disk node relationship in the storage array shown in FIG. 2.

FIG. 4 is a diagram illustrating adding a snapshot for any given snapshot group shown in FIG. 3.

FIG. 5 is a diagram illustrating deleting a snapshot for any given snapshot group shown in FIG. 3.

FIG. 6 is a diagram illustrating the snapshot disk node layout for the storage array shown in FIG. 2.

FIG. 7 is a diagram illustrating the snapshot disk volume layout for the disk nodes shown in FIG. 6.

FIG. 8 is a flowchart for a procedure to create a new snapshot volume in the storage array shown in FIG. 2.

FIG. 9 is a flowchart for a procedure for routing a data access request to a base volume or snapshot volume in the storage array shown in FIG. 2.

FIG. 10 is a flowchart for a procedure for responding to a data write request directed to the base volume in the storage array shown in FIG. 2.

FIG. 11 is a flowchart for a procedure for responding to a data read request directed to a snapshot volume in the storage array shown in FIG. 2.

FIG. 12 is a flowchart for a procedure for responding to a data write request directed to a snapshot volume in the storage array shown in FIG. 2.

FIG. 13 is a flowchart for a procedure for searching for a data block in a snapshot volume in the storage array shown in FIG. 2.

FIG. 14 is a table data structure in which the data block search will be performed for a snapshot volume in the storage array shown in FIG. 2.

FIG. 15 is a flowchart for a procedure to expand data space in a snapshot volume in the storage array shown in FIG. 2.

FIG. 16 is a flowchart for a procedure to calculate disk size for a snapshot volume in the storage array shown in FIG. 2.

FIG. 17 is a flowchart for a procedure automatically updating the history of a base volume using a snapshot volume in the storage array shown in FIG. 2.

### DETAILED DESCRIPTION

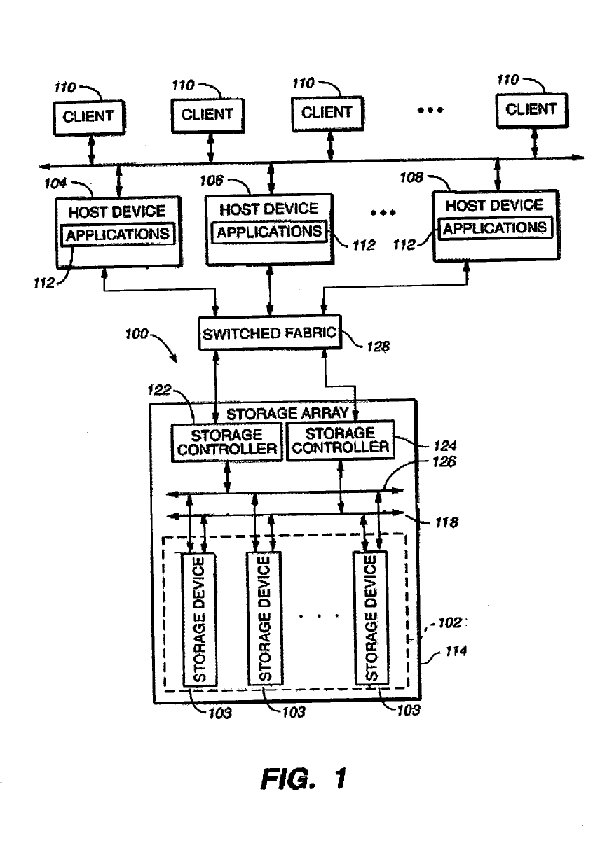

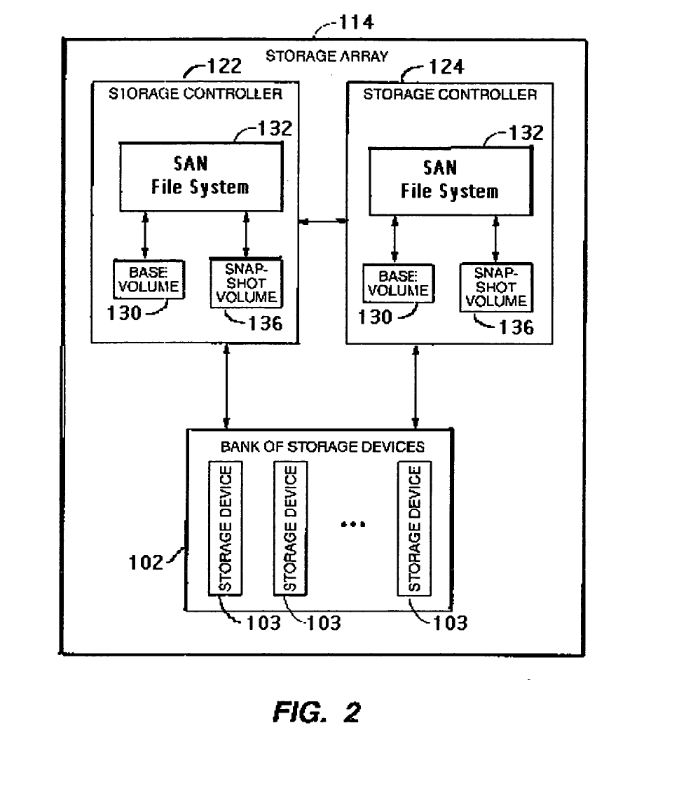

A storage environment, such as a storage area network (SAN) 100 shown in FIG. 1, generally includes conventional storage banks 102 of several conventional storage devices 103 (e.g. hard drives, tape drives, etc.) that are accessed by one or more conventional host devices 104, 106 and 108 typically on behalf of one or more conventional client devices 110 or applications 112 running on the host devices 104-108. The storage devices 103 in the storage banks 102 are incorporated in one or more conventional high-volume, high-bandwidth storage arrays 114. Storage space in the storage devices 103 within the storage array 114 is configured into logical volumes 130 and 136 (FIG. 2). The host devices 104-108 utilize the logical volumes 130 and 136 to store data for the applications 112 or the client devices 110. The host devices 104-108 issue data access requests, on behalf of the client devices 110 or applications 112, to the storage array 114 for access to the logical volumes 130 and 136.

The storage array typically has more than one conventional multi-host channel RAID storage controller (a.k.a. array controller) 122 and 124, as shown in storage array 114. The array controllers 122 and 124 work in concert to manage the storage array 114, to create the logical volumes 130 and 136 (FIG. 2) and to handle the data access requests to the logical volumes 130 and 136 that are received by the storage array 114. The array controllers 122 and 124 separately connect to the storage devices 103 (e.g. each across its own dedicated conventional shared buses 126 and 118) to send and receive data to and from the logical volumes 130 and 136. The array controllers 122 and 124 send and receive data, data access requests, message packets and other communication information to and from the host devices 104-108 through conventional interface ports (not shown) connected to a conventional switched fabric 128. The host devices 104-108 send and receive the communication information through conventional host bus adapters (not shown) connected to the switched fabric 128.

The logical volumes 130 and 136 generally include base volumes 130, snapshot volumes 136, and SAN file systems (SANFS) 132, as shown in FIG. 2. The base volumes 130 generally contain data accessed by the host devices 104-108 (FIG. 1). The snapshot volumes 136 generally contain point-in-time images (described below) of the data contained in the base volumes 130. The SAN file systems 132 generally enable access to the data in the base volumes 130 and snapshot volumes 136. There may be more than one of each of the types of logical volumes 130 and 136 in each storage array 114 (FIG. 1).

The logical volumes 130 and 136 are shown in the storage controllers 122 and 124, since it is within the storage controllers 122 and 124 that the logical volumes perform their functions and are managed. The storage devices 103 provide the actual storage space for the logical volumes 130 and 136.

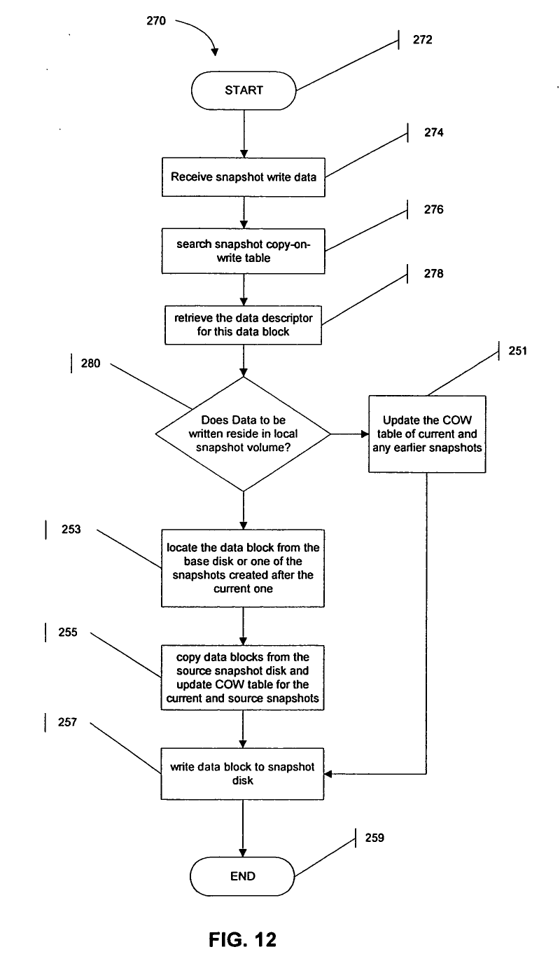

The primary logical volume for storing data in the storage array 114 (FIG. 1) is the base volume 130. The base volume 130 typically stores the data that is currently being utilized by the client devices 110 (FIG. 1) or applications 112 (FIG. 1). If no snapshot volume 136 has yet been created for the base volume 130, then the base volume 130 is the only logical volume present. The snapshot volume 136 is created when it is desired to preserve the state of the base volume 130 at a particular point in time. Other snapshot volumes (described below with reference to FIGS. 12-16) may subsequently be created when it is desired to preserve the state of the base volume 130 or of the snapshot volume 136 at another point in time.

The base volumes 130 and the snapshot volumes 136 are addressable, or accessible, by the host devices 104-108 (FIG. 1), since the host devices 104-108 can typically issue read and write access requests to these volumes. The SAN file systems 132 on the other hand, are not addressable by the host devices 104-108. Instead, the SAN file systems 132 are “internal” to the storage controllers 122 and 124, i.e. they perform certain functions transparent to the host devices 104-108 when the host devices 104-108 access the base volumes 130 and snapshot volumes 136.

Before the snapshot volume 136 is created, the SAN file systems 132 corresponding to the snapshot volume 136 must already have been created. The snapshot volume 136 contains copies of data blocks (not shown) from the corresponding base volume 130. Each data block is copied to the snapshot volume 136 upon the first time that the data stored within the base volume 130 is changed after the point in time at which the snapshot volume 136 is created. The SAN file systems 132 also contains software code for performing certain functions, such as searching for data blocks within the SAN file systems 132 and saving data blocks to the SAN file systems 132 (functions described below). Since the SAN file systems 132 are “internal” to the storage controllers 122 and 124, it only responds to commands from the corresponding base volume 130 and snapshot volume 136, transparent to the host devices 104-108 (FIG. 1).

The snapshot volume 136 represents the state of the data in the corresponding base volume 130 at the point in time when the snapshot volume 136 was created. A data access request that is directed to the snapshot volume 136 will be satisfied by data either in snapshot volume 136 or in the base volume 130. Thus, the snapshot volume 136 may not contain all of the data to be accessed. Rather, the snapshot volume 136 includes actual data and identifiers to the corresponding data in base volume 130 and/or additional instances of snapshot volume 136 within the SAN file systems 132. The snapshot volume 136 also includes software code for performing certain functions, such as data read and write functions (described below), on the corresponding base volume 130 and SAN file systems 132. In other words, the snapshot volume 136 issues commands to “call” the corresponding base volume 130 and SAN file systems 132 to perform these functions. Additionally, it is possible to reconstruct, or rollback, the corresponding base volume 130 to the state at the point in time when the snapshot volume 136 was created by copying the data blocks in the snapshot volume 136 back to the base volume 130 by issuing a data read request to the snapshot volume 136.

The SAN file systems 132 intercepts the data access requests directed to the base volume 130 transparent to the host devices 104-108 (FIG. 1). The SAN file systems 132 includes software code for performing certain functions, such as data read and write functions and copy-on-write functions (functions described below), on the corresponding base volume 130 and the snapshot volume 136.

A SAN file system 132 (a software program labeled SANFS) executes on each of the storage controllers 122 and 124 to receive and process data access commands directed to the base volume 130 and the snapshot volume 136. Thus, the SAN file system 132 “calls,” or issues commands to, the base volume 130 and the snapshot volume 132 to perform the data read and write functions and other functions.

Additionally, the SAN file system 132 executes on each of the storage controllers 122 and 124, respectively to manage the creation and deletion of the snapshot volumes 136, and the base volumes 130 (described below). Thus, the SAN file systems 132 creates all of the desired snapshot volumes 136 from the base volume 130, typically in response to commands to the SAN file system 132 (FIG. 2) under control of a system administrator. The SAN file system 132 also configures the identifiers for the base volume 130 and the snapshot volume 136 and the snapshot volumes 136 with the identifiers for the corresponding base volumes 130 and point-in-time images (described below).

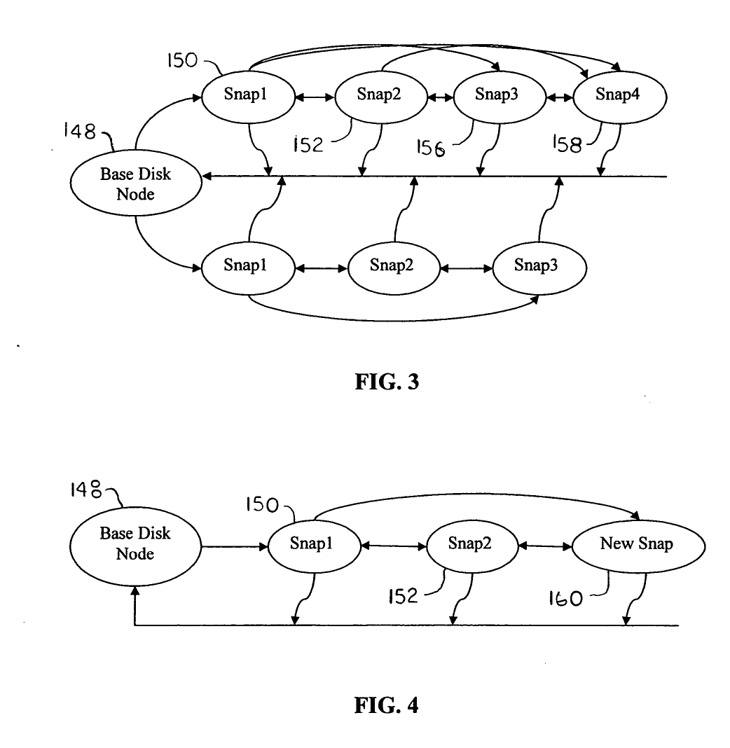

The technique for storing the data for the snapshot volume 136 using multiple point-in-time images is illustrated in FIGS. 3-7. FIG. 3 is a diagram illustrating a memory disk node relationship for the storage array shown in FIG. 2. The memory copies of disk nodes are built by reading the on-disk-node 148. The memory disk nodes have extended data structures (snapshot groups) that form the logical relationship among the snapshots and their base volume 130. As shown in FIG. 3 every snapshot group (snap1 150, snap 2 152, snap3 156, snap 4 158 and so forth) has a pointer back to the base disk node 148.

Furthermore, the base disk node 148 points to its first (most ancient) snapshot, shown as snap1 150 in FIG. 3. Additionally, the base disk node 148 also records the total number of snapshots in a certain group. Also, any snapshot in a group points to all snapshots created after itself and the immediate previous snapshot.

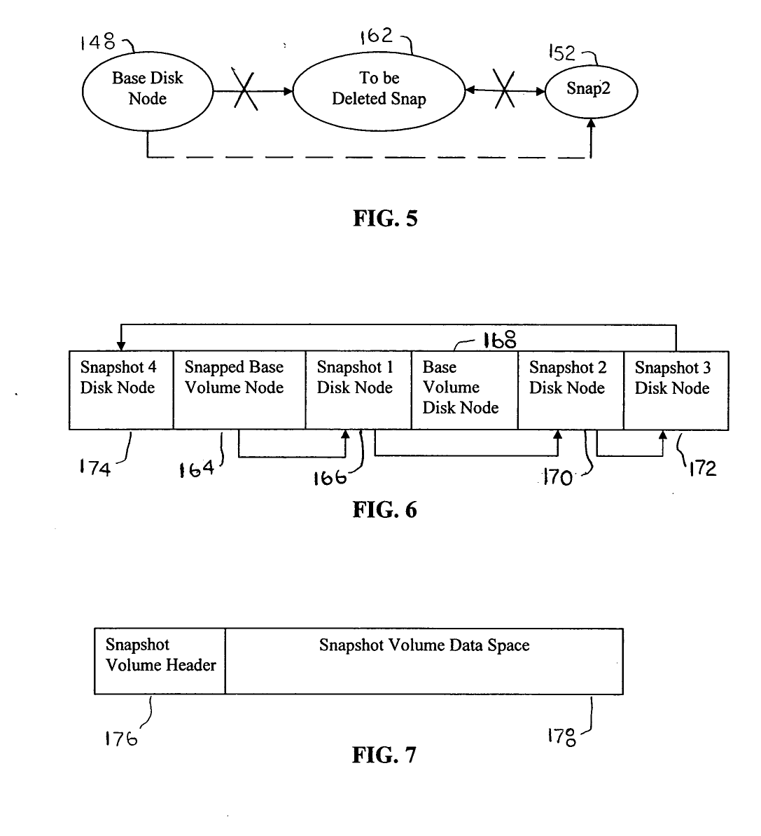

FIG. 4 is a diagram illustrating adding a snapshot for any given snapshot group shown in FIG. 3. As shown in FIG. 4, the new snapshot (new snap) 160 is being added to the end of the last existing snapshot and by way of example in FIG. 4, after snap2 152. FIG. 5 is a diagram illustrating deleting a snapshot for any given snapshot group shown in FIG. 3. As shown in FIG. 5, only the first (most ancient) snapshot 162 may be removed from a snapshot group. After the deletion, the second snapshot 152 becomes the new first snapshot and by way of example in FIG. 5, is snap2 152. FIG. 6 is a diagram illustrating the snapshot disk node on-disk layout for the storage array shown in FIG. 2. The relationship between the base volume 130 and snapshots are stored in the virtual disk nodes (metadata of the virtual disk).

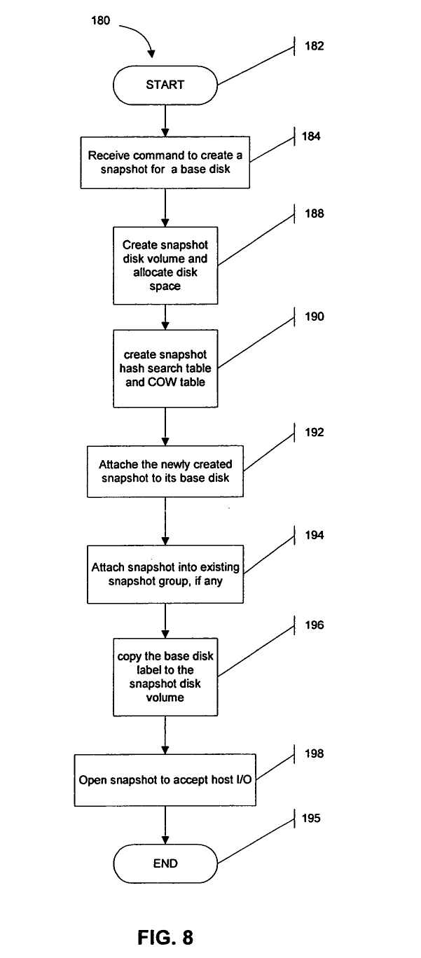

In-memory relationships shown in FIG. 6 are built by reading into memory the base disk node 164, which will direct the loading program to read into memory the snapshot disk node 166 and so on, until all the snapshot disk nodes 170, 172, and 174 are read into the memory. On-disk virtual disk nodes are stored at the beginning and end of the storage pool. FIG. 7 is a diagram illustrating the snapshot disk volume on-disk layout for each of the snapshot disk nodes shown in FIG. 6. The snapshot volume header 176 stores a copy-on-write table (describe more fully below) to enable persistent snapshots (rebuild after system power cycle). The snapshot data space 178 stores the actual copy-on-write data blocks. It should be noted that the data space is always being filled sequentially because snapshot only copies the changed data blocks from the base disk.

A procedure 180 for the SAN file system 132 (FIG. 2) to create a new snapshot volume is shown in FIG. 8. The procedure 180 starts at step 182. At step 184, the SAN file system 132 receives a command, typically under control of a system administrator, to form a snapshot volume from a given “base volume.” At step 188, a snapshot volume 136 is created by allocating storage space in the storage devices 103 (FIGS. 1 and 2). After the disk space is allocated, a Hash search table and copy-on-write (COW) table are created in step 190. The snapshot volume is then attached into the source disk in step 192 and further attached into any existing snapshot group in step 194. The source disk label is then copied into the snapshot volume in step 196 wherein the snapshot volume 136 is opened to host the input/output in step 198. The procedure 180 ends at step 195.

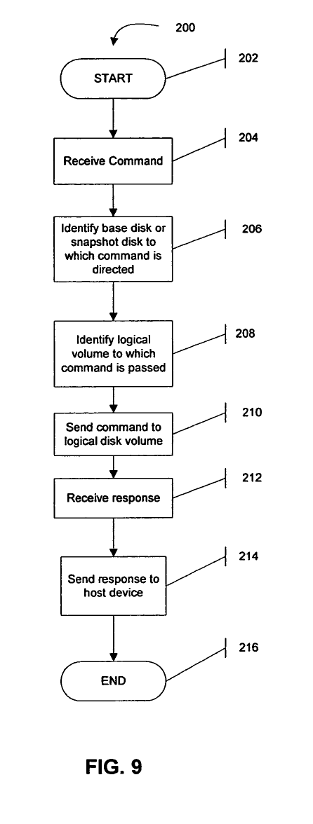

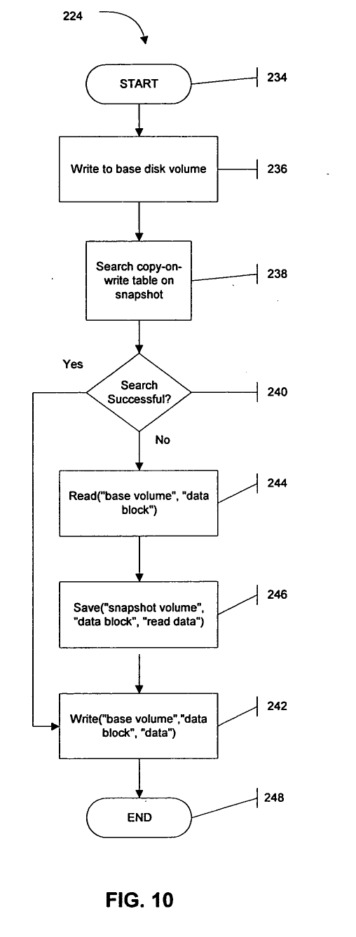

A procedure 200 for the SAN file system 132 (FIG. 2) to route a data access request to a base volume or snapshot volume is shown in FIG. 9. The procedure 200 starts at step 202. At step 204, a command or data access request is received. Information in the command identifies the base volume/disk or snapshot volume/disk to which the command is directed as shown at step 206. The logical volume to which the command is to be passed is identified at step 208. The logical volume is either the base volume or a snapshot volume. The command is then passed to the identified logical volume at step 210. The SAN file system 132 then responds as described below with reference to FIGS. 10-14. The SAN file system 132 receives the response from the logical volume at step 212. The response is then sent to the host device 104-108 that issued the command at step 214. The procedure 200 ends at step 216.

Procedure 224 for a base volume to respond to a data read or write request is shown in FIG. 10. The data read and write requests may be received from the SAN file system 132 (FIG. 2) when the SAN file system 132 passes the command at step 210 in FIG. 9, or the data read and write requests may be received from another logical volume, such as a base volume or a snapshot volume.

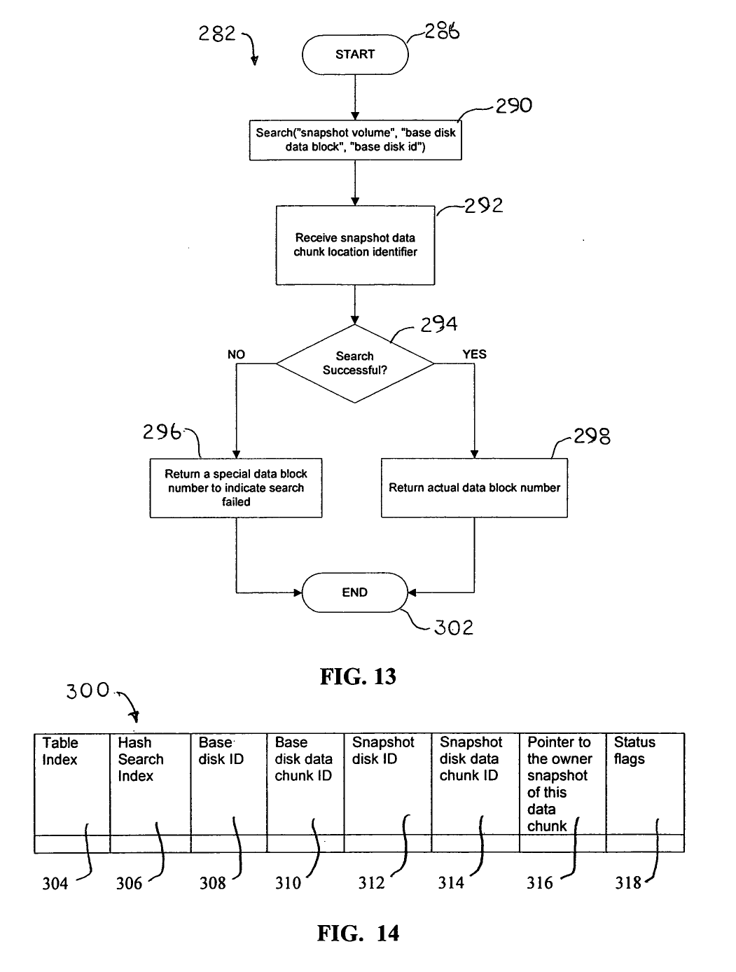

The base write procedure 224 starts at step 234 in FIG. 10. At step 236, the base volume receives the data write request directed to a designated “data block” in its “base volume” and accompanied by the “data” to be written to the “data block”. As discussed above, before the base volume can write the “data” to its “base volume,” the base volume must determine whether a copy-on-write procedure needs to be performed. To make this determination, the base volume issues a search request to its “snapshot volume” to determine whether the “data block” is present in the “snapshot volume” at step 238, because if the “data block” is present in the “snapshot volume,” then there is no need for the copy-on-write procedure. See FIG. 13. At step 240, it is determined whether the search was successful. If so, then the copy-on-write procedure is skipped and the “data” is written to the “data block” in the “base volume” at step 242. If the “data block” is not found (step 240), then the copy-on-write procedure needs to be performed, so the “data block” is read from the “base volume” at step 244, and the “read data” for the “data block” is saved or written to the “snapshot volume” at step 246. After the copying of the “data block” to the “snapshot volume,” the “data” is written to the “data block” in the “base volume” at step 242. The base write procedure 224 ends at step 248.

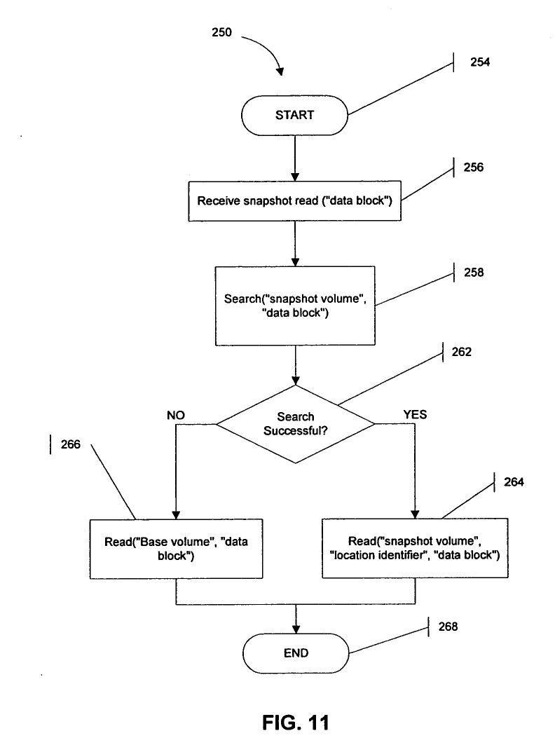

Procedures 250 and 270 are for a snapshot volume to respond to a data read or write request are shown in FIGS. 11 and 12, respectively. The data read and write requests may be received from the SAN file system 132 (FIG. 2) when the SAN file system 132 passes the command at step 210 in FIG. 9, or the data read and write requests may be received from another logical volume, such as another snapshot volume or a base volume issuing a data read request to its “base volume” at step 244 (FIG. 10).

The snapshot read procedure 250 begins at step 254 in FIG. 11. At step 256, the snapshot volume receives the data read request directed to a designated “data block.” The “data block” is in either the “base volume” or “snapshot volume” corresponding to the snapshot volume, so at step 258 a search request is issued to the “snapshot volume” to determine whether the “data block” is present in the “snapshot volume.” See FIG. 13 below. For a data read request, the snapshot volume begins its search for the “data block” in the point-in-time snapshot that corresponds to the data blocks to read. If the search was successful, as determined at step 262, based on the returned “location in volume,” then the “data block” is read from the “location identifier” in the “snapshot volume” at step 264 and the “data block” is returned to the SAN file system 132 (FIG. 2) or the logical volume that issued the data read request to the snapshot volume. If the search was not successful, as determined at step 262, then the “data block” is read from the “base volume” of the snapshot volume at step 266 and the “data block” is returned to the SAN file system 132 or the logical volume that issued the data read request to the snapshot volume. The snapshot read procedure 250 ends at step 268.

The snapshot write procedure 270 begins at step 272 in FIG. 12. At step 272, the snapshot volume receives the data write request directed to a designated “data block” accompanied by the “data” to be written. The snapshot volume is then searched using the copy-on-write table in step 274. The data descriptor for this data block is then retrieved in step 278 wherein it is then determined if the data to be written resides in the local snapshot volume in step 280. If yes, the COW table for the current and any earlier snapshots is updated in step 251 and the data block is written to the snapshot disk in step 257. If it is not the data block is located from the source which may be either the base volume or one of the snapshots created after the current snapshot in step 253. Next, the data blocks from the found source are copied and the COW table and the current and earlier snapshots are updated in step 255. The data block is written to the snapshot disk in step 257. The snapshot write procedure 270 ends at step 259.

The snapshot disk COW table lookup procedure 282 begins at step 286 in FIG. 13. At step 290, the snapshot volume receives the search command to determine whether the “data block” is present in the snapshot volume. From this search the data chunk block or chunk location identifier is received in step 292. The search command was sent, for example, by the base volume at step 238 in the base write procedure 224 shown in FIG. 10. At step 298, the location identifier for the “data block” or “data chunk” is returned if the search 294 was successful. If the search 294 is not successful, this returned location identifier is a pre-defined special value to indicate an invalid value in step 296, otherwise, the real or actual “data block” location identifier will be returned in step 298. The COW table lookup procedure 282 ends at step 302.

The COW table structure 300 in FIG. 14 is created by step 190 (FIG. 8) and is searched by COW table lookup procedure 282. The base disk data block address pair 308 and 310 is mapped to a snapshot disk data block address pair 312 and 314. The COW table 300 defines the table index 304 and has both an in-memory copy and on-disk copy stored in snapshot disk volume header 176 as shown in FIG. 7. During the COW table lookup operation, the incoming data block address information will be collected in the same format as base disk ID 308 and base disk data chunk ID 310. This pair of IDs will be searched with a hash table, using the hash table item pointer 306, to look for any existing entry in the COW table 284. Search result will be returned by snapshot disk COW table lookup procedure 282 in FIG. 13.

The COW table status flag 318 indicates one of the three states of a COW table entry: 1) Unused; 2) Snapshot data blocks chunk is the original base disk data blocks chunk; 3) Snapshot data blocks chunk is a modified copy of the original base disk data blocks chunk. Each COW table entry operates on the block length of snapshot data blocks chunk, whose value is user definable, but not required. Although every snapshot has its own COW table, the actual snapshot data blocks chunk is not necessarily stored in its own disk space. The snapshot disk pointer 316 links a COW table entry to the actual snapshot disk volume where the snapshot data blocks chunk is being stored. By way of example, if a data block on the base disk, having snapshot 1 and snapshot 2, is changed for the first time, a new entry will be added in the COW table of both snapshot 1 and snapshot 2. But the pointer 316 in COW table of snapshot 1 will point to snapshot 2, which is the most recent snapshot that stores the original base data block changed on the base volume. If later on, write to snapshot 1 is on the same data blocks chunk address, the actual snapshot blocks chunk will be first copied from snapshot 2 to snapshot 1, then 316 will be updated to point to snapshot 1, and finally the write to snapshot proceeds.

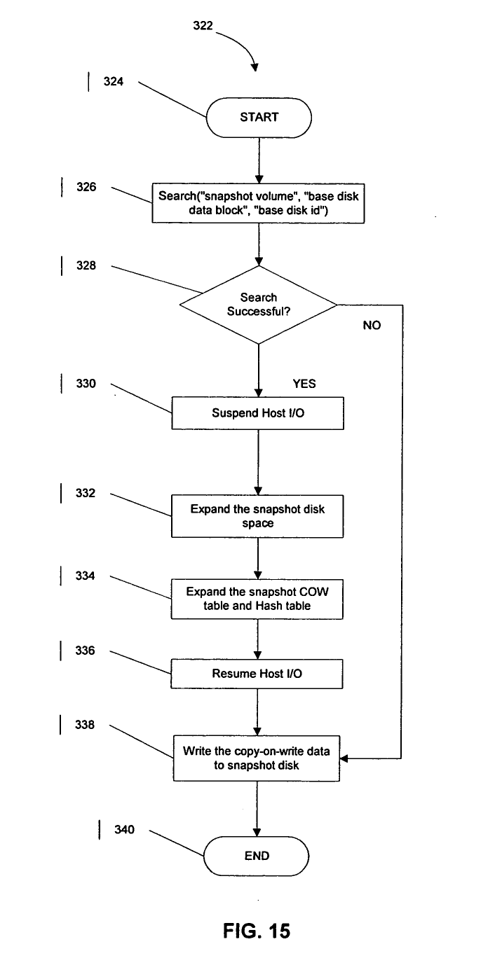

The procedure 322 shown in FIG. 15 to expand data space in a snapshot volume in the storage array begins at step 324. At step 326, Copy-On-Write data is received from the source volume. Next, the free space on the snapshot volume is determined to be above or below a predefined threshold in step 328. If it is not below the predefined threshold, then in step 338 the Copy-On-Write data is written to disk in step 338. If it is below the threshold then the I/O from host 104-108 is temporarily suspended in step 330 without disrupting the current operations on host 104-108, and the disk space is expanded in step 332. Additionally, the snapshot COW table and hash table are expanded in step 334 and then the host I/O is resumed in step 336. The Copy-On-Write data is written to disk in step 338. The data space expansion procedure 322 ends at step 340.

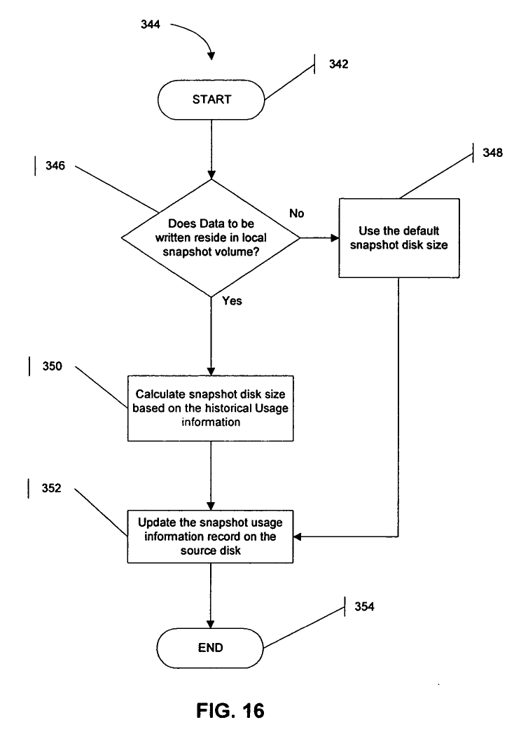

The procedure 344 for calculating the snapshot disk size is shown in FIG. 16 and begins at step 342. The usage information is first searched on the same disk in step 346 and if found is used as the default snapshot disk size in step 348. The snapshot usage information record is then updated on the source disk in step 352. If not found then a calculation is made of the snapshot disk size based on the historical usage information in step 350. The snapshot usage information record is then updated on the source disk in step 352. The calculation of disk size procedure 344 ends at step 354.

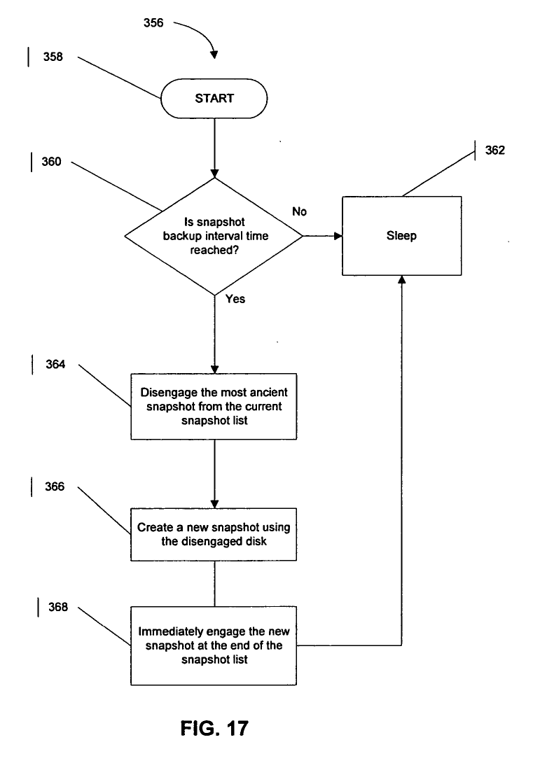

FIG. 17 is a flowchart for a procedure 356 for automatically updating multiple point-in-time copies of a base volume using a number of snapshot volumes in the storage array shown in FIG. 2 and it starts at step 358. First a back-up time interval is checked to see if a snapshot update is required in step 360. If not a sleep condition is invoked in step 362. If the time interval is reached, the most ancient snapshot from the current list is disengaged in step 364. Next, a new snapshot is created using the disengaged disk in step 366. The new snapshot is then immediately engaged back to the end of the disk in step 368 and then put into sleep mode in step 362.

It should be further noted that numerous changes in details of construction, combination, and arrangement of elements may be resorted to without departing from the true spirit and scope of the invention as hereinafter claimed.

What is claimed is:

1. A method for managing multiple snapshot copies of data in a storage area network, comprising:
providing a plurality of different point-in-time read and write accessible snapshot copies of a base disk volume in a storage array wherein said plurality of snapshot copies are all linked together sharing only one copy of a unique data block.

2. The method according to claim 1 for managing multiple snapshot copies of data in a storage area network, comprising:
saving snapshot disk space by dynamically allocating additional space required according to actual usage.

3. The method according to claim 1 for managing multiple snapshot copies of data in a storage area network, comprising:
performing only one copy-on-write procedure needs for said plurality of snapshot copies during access to said base disk volume.

4. The method according to claim 1 for managing multiple snapshot copies of data in a storage area network, comprising:
performing only one copy-on-write procedure for said plurality of snapshot volumes during access to any said plurality of snapshots copies that are attached to said base disk volume.

5. The method according to claim 1 for managing multiple snapshot copies of data in a storage area network, comprising:
deleting a snapshot copy wherein disk space and data structure dedicated to that snapshot copy are also deleted such that storage space and memory resource within said plurality snapshot copies may be reused for subsequent applications.

6. The method according to claim 1 for managing multiple snapshot copies of data in a storage area network, comprising:
maintaining and updating, different point-in-time snapshot copies of said base disk volume.

7. The method according to claim 1 for managing multiple snapshot copies of data in a storage area network, comprising:
managing said plurality of snapshot copies and said base disk volume by a storage area network file located within an array controller.

8. The method according to claim 1 for managing multiple snapshot copies of data in a storage area network, comprising:
adding a snapshot copy to said plurality of snapshot copies by adding to an end of a last snapshot copy thereby continuing said link of said plurality of snapshot copies.

9. The method according to claim 1 for managing multiple snapshot copies of data in a storage area network, comprising:
deleting a snapshot copy to said plurality of snapshot copies by deleting a first snapshot copy wherein a second snapshot copy becomes a first snapshot copy thereby continuing said link of said plurality of snapshot copies.

10. A storage area network system, comprising:
a storage array having one or more storage controllers;
a storage area network file system located within said one or more storage controllers for controlling a base volume and one or more snapshot volumes wherein said snapshot volumes are a plurality of different point-in-time read and write accessible snapshot copies of said base volume and said plurality of snapshot copies are all linked together sharing only one copy of a unique data block.

11. The storage area network system according to claim 10 wherein said one or more storage controllers separately connect to storage devices across dedicated buses.

12. The storage area network system according to claim 10 wherein snapshot disk space of said snapshot volumes is saved by dynamically allocating additional space required according to actual usage.

13. The storage area network system according to claim 10 wherein only one copy-on-write procedure needs to be performed for said plurality of snapshot copies during access to said base volume by said system area network file system.

14. The storage area network system according to claim 10 wherein only one copy-on-write procedure needs to be performed for said plurality of snapshot volumes during access to any said plurality of snapshots copies by said system area network file system.

15. The storage area network system according to claim 10 wherein a snapshot copy that is deleted has its disk space and data structure dedicated to that snapshot copy also deleted such that storage space and memory resource within said plurality snapshot copies may be reused for subsequent applications.

16. The storage area network system according to claim 10 wherein point-in-time snapshot copies of said base disk volume are maintained and updated by said storage area network file system.

17. The storage area network system according to claim 10 wherein said plurality of snapshot copies and said base disk volume are managed by a storage area network file located within an array controller and further managed by said base disk volume.

18. The storage area network system according to claim 10 wherein a snapshot copy is added to said plurality of snapshot copies by adding to an a last snapshot copy thereby continuing said link of said plurality of snapshot copies.

19. The storage area network system according to claim 10 wherein a snapshot copy is deleted to said plurality of snapshot copies by deleting a first snapshot copy wherein a second snapshot copy becomes a first snapshot copy thereby continuing said link of said plurality of snapshot copies.

20. A storage area network system comprising:
means for providing a plurality of different point-in-time read and write accessible snapshot copies of a base disk volume in a storage array wherein said plurality of snapshot copies are all linked together sharing only one copy of a unique data block;
means for saving snapshot disk space by dynamically allocating additional space required according to actual usage; and
means for performing only one copy-on-write procedure needs for said plurality of snapshot copies during access to said base disk volume.
